(19) United States
(12) Patent Application Publication
(10) Pub. No.: US 2008/0121441 A1
(43) Pub. Date: May 29, 2008

(54) SYSTEMS AND METHODS FOR MUTUALLY EXCLUSIVE OPTIONS ON A PAPER FORM FOR USE WITH A DIGITAL PEN

(75) Inventors: Rodney L. Sheets, Salt Lake City, UT (US); Tuan Van Le, West Valley City, UT (US)

Correspondence Address: STOEL RIVES LLP - SLC, 201 SOUTH MAIN STREET, ONE UTAH CENTER, SALT LAKE CITY, UT, 84111, US

(73) Assignee: VELOSUM, INC., Sandy, UT (US)

(21) Appl. No.: 11/747,412

(22) Filed: May 11, 2007

Related U.S. Application Data
(60) Provisional application No. 60/799,669, filed on May 12, 2006.

(51) Int. Cl. G06F 3/041

(52) U.S. Cl. 178/18.01

(57) ABSTRACT

Systems and methods are provided for selecting a user-identified option from among a group of mutually exclusive options. In one embodiment a user marks the user-identified option on a paper form using a digital pen. A stroke collection file includes data corresponding to a set of digital pen strokes. A system determines a subset of the digital pen strokes that are associated with the group of mutually exclusive options. A last pen stroke in the subset made by the user is determined to be the pen stroke intended by the user for selecting among the group of mutually exclusive options.

### RELATED APPLICATION

This application claims the benefit under 35 U.S.C. §119(e) of U.S. Provisional Application No. 60/799,669, filed May 12, 2006, which is hereby incorporated by reference herein in its entirety.

### TECHNICAL FIELD

This disclosure relates to electronically filling out a paper form using a digital pen. More specifically, this disclosure relates to processing a user selection from among a group of mutually exclusive options presented on a paper form using a digital pen.

### BRIEF DESCRIPTION OF THE DRAWINGS

Non-limiting and non-exhaustive embodiments of the disclosure are described, including various embodiments of the disclosure with reference to the figures, in which:

FIG. 1 is a block diagram of an example system for processing data received from a digital pen according to one embodiment;

FIG. 2 is a block diagram of a data structure for a stroke collection file according to one embodiment;

FIG. 3 is a block diagram illustrating a process flow for determining a mutually exclusive option selected by a user with a digital pen according to one embodiment;

FIG. 4 is a block diagram illustrating a process flow for determining which of a plurality of marked mutually exclusive options were intended to be selected by a user with a digital pen according to one embodiment;

FIG. 5 is a block diagram of a data structure for a group option list for a particular group of mutually exclusive options according to one embodiment;

FIG. 6 is a flowchart of a process for determining a user selection from among a plurality of mutually exclusive options on a paper form using a digital pen according to one embodiment;

FIG. 7 graphically illustrates an example parking ticket including mutually exclusive options that may be processed according to certain embodiments;

FIG. 8A graphically illustrates a vehicle state field shown in FIG. 7 including two mutually exclusive options marked by a user according to one embodiment;

FIG. 8B graphically illustrates a rendered image of the vehicle state field shown in FIG. 8A as displayed after discarding a user written checkmark according to one embodiment;

FIG. 9A graphically illustrates a vehicle make field shown in FIG. 7 including three mutually exclusive options marked by a user; and

FIG. 9B graphically illustrates a rendered image of the vehicle make field shown in FIG. 9A as displayed after discarding two of three user written checkmark according to one embodiment.

### DETAILED DESCRIPTION OF THE PREFERRED EMBODIMENTS

A user may write on a paper form using a digital pen that both marks the form and electronically records the marks in relation to various form fields. Thus, user selections made using the paper form and the digital pen may be automatically determined and an electronic image of the paper form may be generated that includes the user's marks. Digital pens usable with the disclosure herein include, for example, a digital pen available from Anoto AB of Stockholm, Sweden (also referred to herein as an “Anoto-type pen”), a digital pen available from Hitachi Maxell Ltd. of Tokyo, Japan, or a digital pen available from Logitech Inc. of Freemont, Calif., USA.

Paper forms may include a group of mutually exclusive options from which a user may select a single option. For example, a portion of a form may allow a user to indicate whether the user is male or female, indicate yes or no to a question, indicate a single state where the user resides, indicate a single favorite color, or any other mutually exclusive option. The mutually exclusive options may, for example, be in the form of user selectable check boxes, a group of words or symbols that a user may selectively circle or mark, an area where a user may write words or symbols, or combinations of the foregoing.

As discussed in detail below, a user's pen strokes on a paper form using a digital pen are analyzed to determine a single selection from a group of mutually exclusive options. If the user has selected more than one option from the group, the system determines that the last pen stroke made in the group corresponds to the selected option. In one embodiment, an option flag corresponding to the selected option is set. In another embodiment, the selected option is stored in a database record.

In one embodiment, a group identifier (ID) is associated with a group of mutually exclusive options and respective group member IDs are associated with each member or option in the group. The system determines the order in which a user makes each pen stroke. The system also determines a location of each pen stroke with respect to predetermined form fields. If the location of a particular pen stroke corresponds to the location of a particular option within a mutually exclusive group, the system associates the pen stroke with the corresponding group ID and group member ID. The system then selects the group member ID corresponding to the last pen stroke made by the user within the mutually exclusive group.

In one embodiment, the system determines the user's selection from the group of mutually exclusive options after the user has completed the form and submitted the data collected by the digital pen for processing. In addition, or in other embodiments, a user may also update a previously processed form by marking a new selection with the digital pen from the group of mutually exclusive options and submitting the additional data collected by the digital pen for processing. The system associates the additional data with the previously submitted data and determines whether the user has replaced a previously selected option with a new option in a group of mutually exclusive options.

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a machine-readable medium having stored thereon instructions that may be used to program a computer (or other electronic device) to perform processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

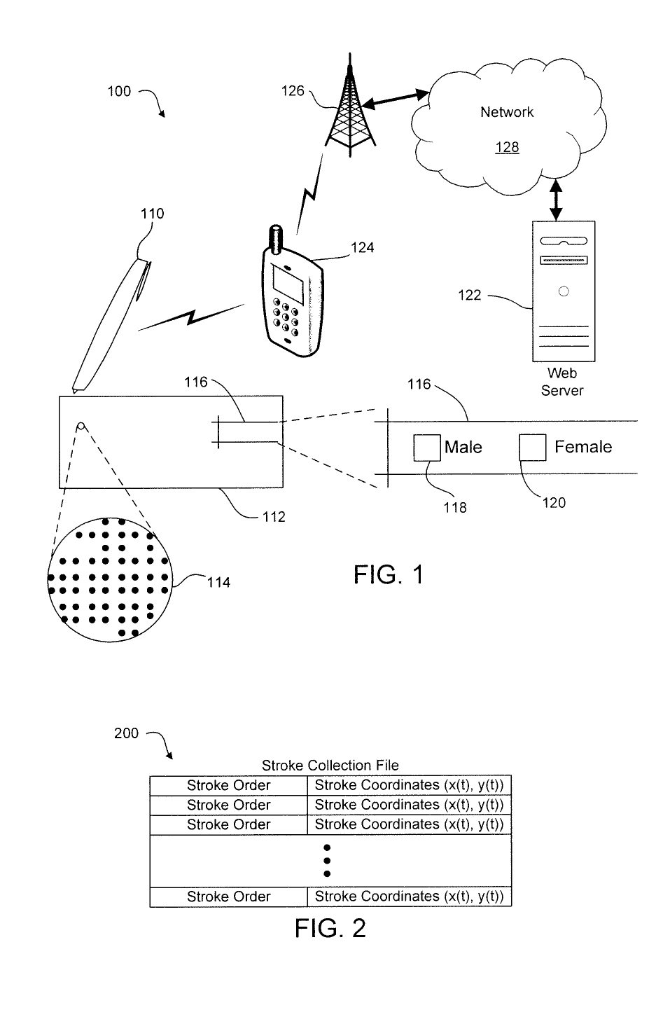

FIG. 1 is a block diagram of an example system 100 for processing data received from a digital pen 110 according to one embodiment. The digital pen 110 is configured to write on a paper form 112 and to electronically capture pen strokes in relation to a position-coding pattern 114 on a writing surface of the form 112. As discussed above, the digital pen 110 may include an Anoto-type pen. Thus, although not shown, the digital pen 110 may include a ball point tip, an ink cartridge, a camera with a lens that is directed toward the ball point tip, a pressure sensitive sensor that activates when pressure is applied to the ball point tip, a processor, a memory device, a communication device, and a power source. However, an artisan will recognize from the disclosure herein that other types of digital pens known in the art may also be used.

In one embodiment, a user may use the digital pen to make pen strokes (e.g., in ink) on the form 110. The digital pen 110 determines the location of the pen strokes on the form 112 relative to the position-coding pattern 114 by analyzing the position-coding pattern 114 as pressure is applied to the ball point tip. Thus, each pen stroke is associated with a series of coordinates (x(t), y(t)) in, for example, a Cartesian coordinate system defined by the position-coding pattern 114. Here, x(t) corresponds to a unique location in the position-coding pattern 114 along an x-axis at a particular time during the stroke. Similarly, y(t) corresponds to a unique location in the position-coding pattern 114 along a y-axis at a particular time during the stroke.

In one embodiment, the form 112 includes one or more predetermined form fields 116 that a user may mark using the digital pen 110 to make a particular selection. The field 116 may include two or more mutually exclusive options. In the example shown in FIG. 1, the field 116 is enlarged to illustrate that is a gender field with a first mutually exclusive option 118 (Male) and a second mutually exclusive option 120 (Female). An artisan will recognize from the disclosure herein, of course, that any type of mutually exclusive options may be used and is not limited to a selection between male and female options.

The field 116 and corresponding mutually exclusive options 118, 120 may be preprinted on the form 112 at predetermined locations with respect to the position-coding pattern 114. Thus, the position of a pen stroke relative to the position-coding pattern 114 may be used to determine if the user has marked a location within an area defined by the field 116 and one of the mutually exclusive options 118, 120.

Data for each stroke collected by the digital pen 110 may be stored in a stroke collection file that is communicated to a web server 122 through, for example, a user's cellular phone 124, a wireless communication system 126, and a network 128 such as the Internet or a local area network (LAN). The web server 122 includes a processor for performing software instructions on the data received from the digital pen 110, as described herein. In addition, or in another embodiment, the cellular phone 124 may also perform part or all of the processing on the data received from the digital pen 110. In one embodiment, the digital pen transmits data to the cellular phone 124 using Bluetooth®. In addition, or in another embodiment, the data may be retrieved from the digital pen 110 through a cable or docking station.

FIG. 2 is a block diagram of a data structure for an example stroke collection file 200 according to one embodiment. As a user makes a pen stroke on the form 112 using the digital pen 110, the digital pen 110 assigns a stroke order (e.g., first, second, third, etc.) to the stroke relative to previous pen strokes, if any, made on the particular form 112. After determining the coordinates (x(t), y(t)) of the stroke in relation to the position-coding pattern 114, the digital pen adds the stroke's stroke order and stroke coordinates to the stroke collection file 200. When the user indicates that the form is complete (e.g., by marking a predetermined location on the form 112), the digital pen transmits the stroke collection file 200 to the cellular phone 124 for further processing and transmission to the web server 122.

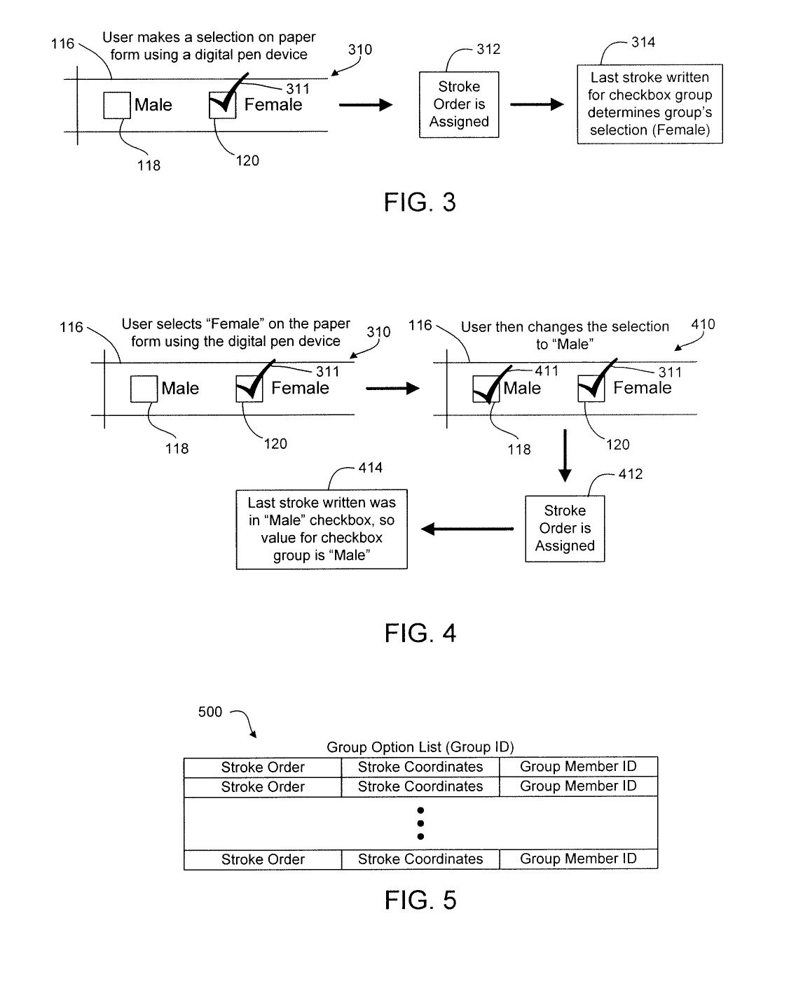

The gender field 116 shown in the example in FIG. 1 allows a user to specify the user's gender as either male or female. FIGS. 3 and 4 are block diagrams illustrating process flows for determining which of the mutually exclusive options 118, 120 the user selects. In FIG. 3, the user selects 310 female by writing a first check mark 311 in the “Female” checkbox 120 using the digital pen 110. The digital pen 110 then assigns 312 a stroke order (e.g., first stroke) to the first check mark 311 and adds the stroke order and the stroke coordinates (x(t), y(t)) corresponding to the first check mark 311 to the stroke collection file 200.

In the example shown in FIG. 3, the user finishes filling out the form 112 without adding additional marks within the gender field 116 and the digital pen transmits the stroke collection file 200 to the web server 122 via the cellular phone 124. The web server 122 accesses the stroke collection file 200 and determines that the stroke coordinates (x(t), y(t)) for to the first checkmark 311 correspond to predetermined coordinates for the “Female” option 120 of the gender field 116. The web server 122 then determines 314 that the last stroke written in the gender field 116 (e.g., the checkbox group corresponding to the mutually exclusive options 118, 120) is the user selected option. Because the “Female” option 120 was the only box marked in the gender field 116, the web server 122 determines that the user intended to select the female option.

In the example shown in FIG. 4, the user mistakenly marks two of the mutually exclusive options and the web server 122 determines that the last option marked by the user is the selected option. As discussed above, in this example the user first selects 310 female by writing the first check mark 311 in the “Female” checkbox 120 using the digital pen 110. The digital pen 110 then assigns 312 a stroke order (e.g., first stroke) to the first check mark 311 and adds the stroke order and the stroke coordinates (x(t), y(t)) corresponding to the first check mark 311 to the stroke collection file 200.

After realizing a mistake has been made, the user then selects 410 male by writing a second check mark 411 in the “Male” checkbox 118 using the digital pen 110. The digital pen 110 then assigns 412 a stroke order (e.g., second stroke) to the second check mark 411 and adds the stroke order and the stroke coordinates (x(t), y(t)) corresponding to the second check mark 411 to the stroke collection file 200.

When the user finishes filling out the form 112, the digital pen 110 transmits the stroke collection file 200 to the web server 122 via the cellular phone 124. The web server 122 accesses the stroke collection file 200 and determines that the first checkmark 311 and the second checkmark 411 correspond to the same field 116. The web server 122 then determines 414, based on the respective stroke orders in the stroke collection file 200, that the user intended to select the male option because the second checkmark 411 was added to the stroke collection file after the first checkmark 311.

As discussed above, in one embodiment, a group ID is associated with the field 116 and respective group member IDs are associated with each of the mutually exclusive options 118, 120 within the field 116. In such an embodiment, the web server 122 loops through the stroke collection file 200 and adds each of the strokes having stroke coordinates (x(t), y(t)) corresponding to the field 116 to a group option list.

For example, FIG. 5 is a block diagram of a data structure for a group option list 500 for a particular group ID (e.g., corresponding to the field 116) according to one embodiment. As the web server 122 identifies strokes in the stroke collection file 200 corresponding to the group ID, the web server 122 adds the stroke's stroke order, stroke coordinates (x(t), y(t)), and corresponding group member ID to the group option list 500. The web server 122 then identifies the stroke in the group option list 500 having the highest stroke order (e.g., the last stroke written by the user) and selects its corresponding group member ID as the user's selection for the corresponding group ID.

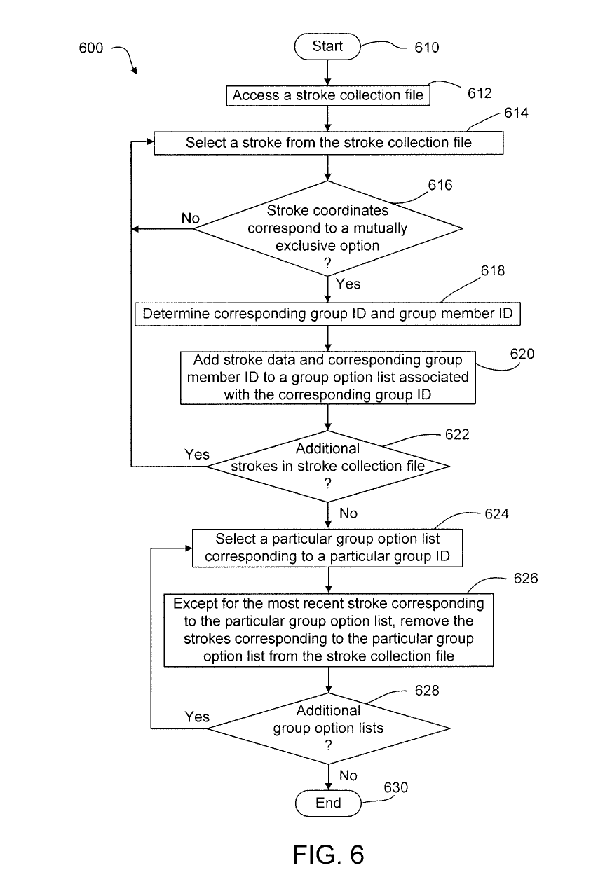

FIG. 6 is a flowchart of a process 600 for determining a user selection from among a plurality of mutually exclusive options on a paper form using a digital pen according to one embodiment. After starting 610, the process 600 accesses 612 a stroke collection file that includes data collected by a digital pen. As discussed above, the data in the stroke collection file may include a stroke order and stroke coordinates (x(t), y(t)) for each stroke in the stroke collection file.

The process 600 then selects 614 a stroke from the stroke collection file and determines 616 whether the selected stroke's stroke coordinates correspond to a mutually exclusive option. If not, the process 600 selects 614 another stroke from the stroke collection file. If, however, the selected stroke's stroke coordinates correspond to a mutually exclusive option, the process determines a corresponding group ID and group member ID corresponding to the selected stroke, as discussed above.

The process 600 then adds 620 data corresponding to the stroke (e.g., a stroke order and stroke coordinates (x(t), y(t))) and the corresponding group member ID to a group option list associated with the corresponding group ID. The process 600 queries 622 whether there are additional strokes in the stroke collection file. If there are additional strokes in the stroke collection file, the process 600 selects 614 another stroke from the stroke collection file and determines whether the stroke should be added to a group option list, as described above.

If there are no additional strokes in the stroke collection file, the process 600 selects 624 a particular group option list corresponding to a particular group ID. Except for the most recent stroke (e.g., the last stroke made by the user) corresponding to the particular group list, the process 600 removes 626 the strokes corresponding to the particular group option list from the stroke collection file.

The process 600 then queries 628 whether there are additional group option lists. If there are additional group option lists, the process 600 selects 624 another group option list and removes corresponding strokes from the stroke collection file, as discussed above. If there are no additional group option lists, the process 600 ends 630. Thus, the process 600 resolves conflicts between multiple user selections in a mutually exclusive group of options.

Although not shown in FIG. 6, in one embodiment, after processing the stroke collection file, a new stroke collection file is received to update the previous stroke collection file (e.g., after new additions and/or corrections have been made to the paper form using the digital pen. In such an embodiment, the process 600 is repeated for the new stroke collection file and, if appropriate, strokes from the new stroke collection file may replace strokes in the previous stroke collection file.

Although not shown in FIG. 6, in some embodiments, the process 600 may also include rendering an image of the paper form with the plurality of mutually exclusive options and pen strokes made by the user with the digital pen. The image may be displayed, for example, on a computer screen and/or printed on a printer. In certain such embodiments, the strokes removed from the stroke collection file, as discussed above, are not included in the rendered image.

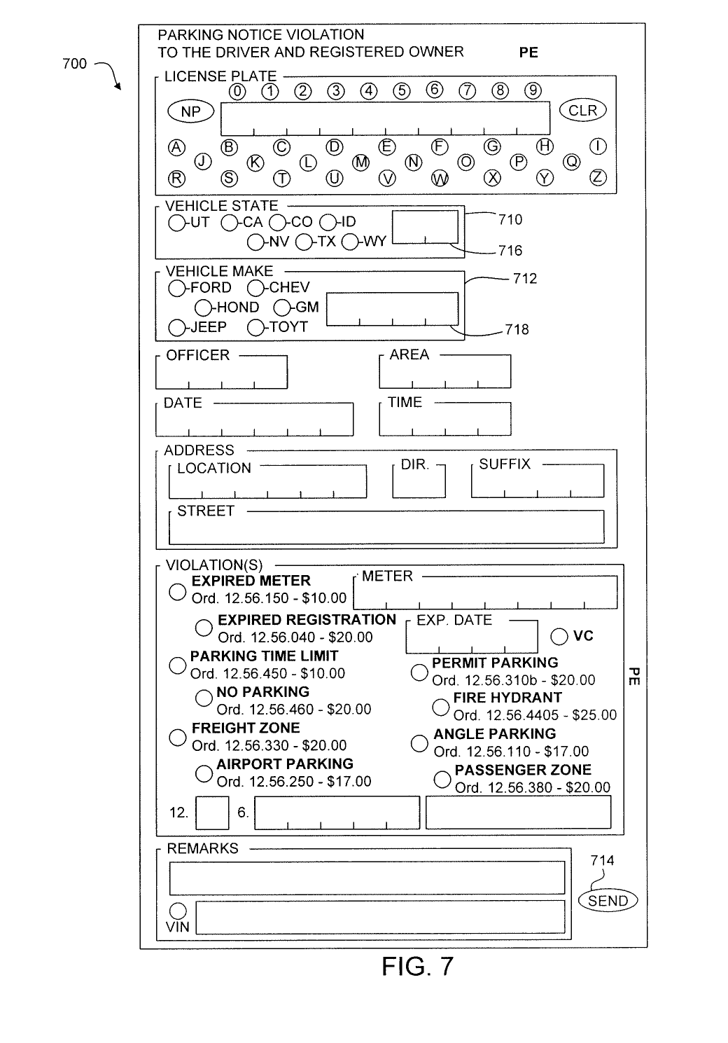

FIG. 7 graphically illustrates an example parking ticket 700 (Parking Notice Violation to the Driver and Registered Owner) with fields 710, 712 that respectively include mutually exclusive options that may be processed according to certain embodiments disclosed herein. In one embodiment, the parking ticket 700 is a paper form including a position-coding pattern that is detectable by a digital pen, as discussed above. The parking ticket 700 may be filled out by a user such as a police officer or parking enforcement official using the digital pen.

When the user is finished writing information on the parking ticket 700, the user may write a pen stroke in or through a send field 714, which instructs the digital pen to send the data it has collected to the user's cellular phone or other communication device. The user who wrote the ticket 700 may then leave the paper copy of the parking ticket 700 on a vehicle's windshield. The data collected by the digital pen may be sent to and automatically processed by a central web server that may enter field selections in a searchable database and/or render an electronic image of the parking ticket 700 with the desired pen strokes written by the user. The data may be used for violation enforcement and in automating the fine collection process.

In the example embodiment shown in FIG. 7, a vehicle state field 710 allows the user to specify a state that issued a license plate for a vehicle in violation of a parking ordinance. Using a digital pen, the user may select one of a plurality of predefined states by writing a mark in a circle (or other symbol) next to the state's name or abbreviation. In this example, the predefined states include Utah (UT), California (CA), Colorado (CO), Idaho (ID), Nevada (NV), Texas (TX), or Wyoming (WY). If the license plates were issued by a state other than one of the predefined states, the user may also write the abbreviation of the appropriate state within a text box 716 in the vehicle state field 710.

Because vehicles are generally licensed by only one state at a time, the user is allowed to select only one state, either by marking one of the circles or writing in the state's abbreviation, in the vehicle state field 710. Thus, if the user selects more than one state, the last state selected by the user is determined to be the state intended by the user.

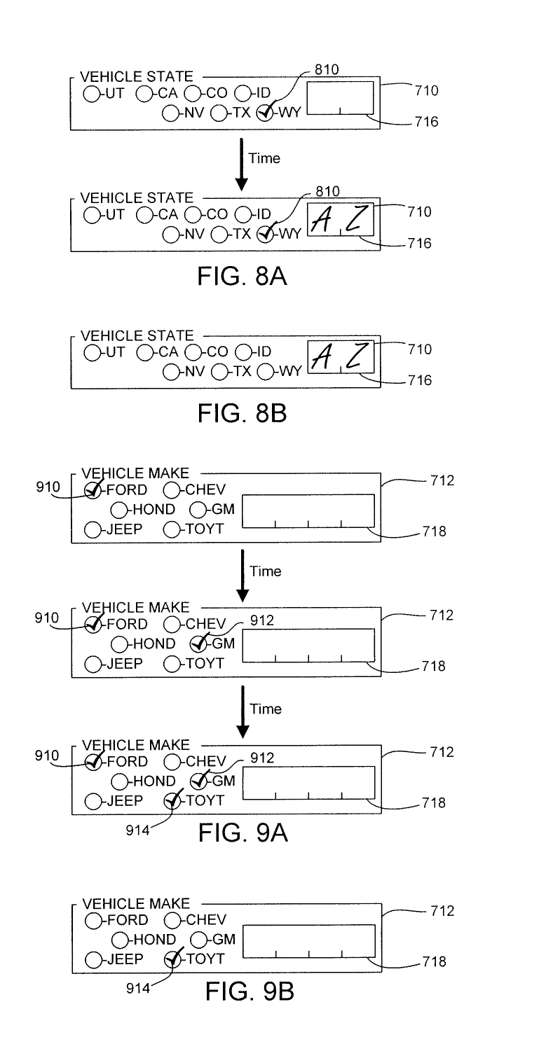

For example, FIG. 8A graphically illustrates the vehicle state field 710 shown in FIG. 7 including two mutually exclusive options marked by the user. As shown, the user first wrote a checkmark 810 in a circle labeled “WY” to indicate that the license plate was issued by the state of Wyoming. Subsequently, however, the user wrote the letters “A” and “Z” in the text box 716 so as to indicate that the license plate was issued by the state of Arizona. Because “A” and “Z” were the last strokes entered into the vehicle state field 710, the web server 122 assumes that the user mistakenly wrote the checkmark 810. Thus, the web server ignores or discards the checkmark 810.

FIG. 8B graphically illustrates a rendered image of the vehicle state field 710 as displayed after the web server has discarded the checkmark 810 according to one embodiment. Thus, the systems and methods disclosed herein allow a user to easily correct a mistakenly marked mutually exclusive option on a paper form.

By way of another example, a vehicle make field 712 shown in FIG. 7 allows the user to further identify the vehicle in violation of the parking ordinance by specifying the manufacturer of the vehicle. Using the digital pen, the user may select one of a plurality of predefined automobile manufacturers by writing a mark in a circle (or other symbol) next to the manufacturer's name or abbreviation. In this example, the predefined manufacturers include Ford (FORD), Chevrolet (CHEV), Honda (HOND), General Motors (GM), Jeep (JEEP), and Toyota (TOYT). If the vehicle was made by a manufacturer other than one of the predefined manufacturers, the user may also write the name or abbreviation of the appropriate manufacturer within a text box 718 in the vehicle make field 712.

Because vehicles are generally made by only one manufacturer, the user is allowed to select only one manufacturer, either by marking one of the circles or writing in the manufacturer's name or abbreviation, in the vehicle make field 712. Thus, if the user selects more than one manufacturer, the last manufacturer selected by the user is determined to be the manufacturer intended by the user.

For example, FIG. 9A graphically illustrates the vehicle make field 712 shown in FIG. 7 including three mutually exclusive options marked by the user. As shown, the user wrote a first checkmark 910 in a circle labeled “FORD” to indicate that the vehicle was made by Ford. Subsequently, however, the user wrote a second checkmark 912 in a circle labeled “GM” to indicate that the vehicle was made by General Motors. Finally, the user wrote a third checkmark 914 in a circle labeled “TOYT” to indicate that the vehicle was made by Toyota. Because the third checkmark 914 was the last stroke written in the vehicle make field 712, the web server assumes that the user mistakenly wrote the first checkmark 910 and the second checkmark 912. Thus, the web server ignores or discards the first checkmark 910 and the second checkmark 912.

FIG. 9B graphically illustrates a rendered image of the vehicle make field 712 as displayed after the web server has discarded the first checkmark 910 and the second checkmark 912 according to one embodiment.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure.

What is claimed is:

1. A method for selecting a user-identified option from among a group of mutually exclusive options, the user-identified option being marked by a user with a digital pen on a paper form, the method comprising:
accessing a stroke collection file comprising data corresponding to a set of digital pen strokes;
determining a subset of digital pen strokes associated with the group of mutually exclusive options;
determining a last digital pen stroke in the subset made by the user, the last digital pen stroke being associated with a particular option in the group of mutually exclusive options; and
selecting the particular option associated with the last digital pen stroke as the user-identified option from among the group of mutually exclusive options.

2. The method of claim 1, further comprising rendering an image of the paper form, the image comprising:
the group of mutually exclusive options; and
a single pen stroke among the group of mutually exclusive options, the single pen stroke comprising an image of the last digital pen stroke substantially located as marked by the user in relation to the particular option.

3. The method of claim 2, wherein rendering the image of the paper form comprises:
removing data from the stroke collection file corresponding to a first digital pen stroke in the subset made by the user; and
rendering the image based on the modified stroke collection file.

4. The method of claim 1, wherein selecting the particular option associated with the last digital pen stroke as the user-identified option comprises setting an option flag to the particular option, the option flag corresponding to the group of mutually exclusive options.

5. The method of claim 1, wherein determining the subset of digital pen strokes associated with the group of mutually exclusive options comprises:
associating the group of mutually exclusive options with an area on the paper form corresponding to a first set of coordinates;
accessing a second set of coordinates corresponding to a particular stroke in the stroke collection file; and
comparing the second set of coordinates to the first set of coordinates to determine whether the particular stroke was written within the area associated with the field.

6. The method of claim 5, wherein determining a last digital pen stroke in the subset comprises:
determining a stroke order for each of the digital pen strokes in the subset, the stroke order corresponding to an order in which the user wrote the stroke on the paper form using the digital pen; and
based on the stroke order, selecting the last digital pen stroke.

7. The method of claim 6, further comprising:
selecting a third set of coordinates from among the first set of coordinates, the third set of coordinates corresponding to the particular option in the group of mutually exclusive options;
selecting a fourth set of coordinates from among the second set of coordinates, the fourth set of coordinates corresponding to the last digital pen stroke; and
comparing the third set of coordinates to the fourth set of coordinates to determine whether last digital pen stroke corresponds to the particular option.

8. A system for selecting a user-identified option from among a group of mutually exclusive options, the system comprising:
a digital pen configured to write pen strokes on a paper form and to store corresponding stroke coordinates associated with respective pen stroke locations on the paper form; and
a processor configured to:
determine set of digital pen strokes associated with the group of mutually exclusive options;
determine a last digital pen stroke in the set of digital pen strokes made by the user, the last digital pen stroke being associated with a particular option in the group of mutually exclusive options; and
select the particular option associated with the last digital pen stroke as the user-identified option from among the group of mutually exclusive options.

9. The system of claim 8, further comprising a wireless communication device configured to receive the stroke coordinates and from the digital pen and to provide the stroke coordinates to the processor.

10. The system of claim 8, wherein the processor comprises a web-based server.

11. The system of claim 8, wherein the processor is further configured to render an image of the paper form, the image comprising:
the group of mutually exclusive options; and
a single pen stroke among the group of mutually exclusive options, the single pen stroke comprising an image of the last digital pen stroke substantially located as marked by the user in relation to the particular option.

12. The system of claim 8, wherein selecting the particular option associated with the last digital pen stroke as the user-identified option comprises setting an option flag to the particular option, the option flag corresponding to the group of mutually exclusive options.

13. The system of claim 8, wherein determining the subset of digital pen strokes associated with the group of mutually exclusive options comprises:
associating the group of mutually exclusive options with an area on the paper form corresponding to a first set of coordinates;
accessing a second set of coordinates corresponding to a particular stroke; and
comparing the second set of coordinates to the first set of coordinates to determine whether the particular stroke was written within the area associated with the field.

14. The system of claim 13, wherein determining a last digital pen stroke in the subset comprises:
determining a stroke order for each of the digital pen strokes in the subset, the stroke order corresponding to an order in which the user wrote the stroke on the paper form using the digital pen; and
based on the stroke order, selecting the last digital pen stroke.

15. The system of claim 14, further comprising:
selecting a third set of coordinates from among the first set of coordinates, the third set of coordinates corresponding to the particular option in the group of mutually exclusive options;
selecting a fourth set of coordinates from among the second set of coordinates, the fourth set of coordinates corresponding to the last digital pen stroke; and
comparing the third set of coordinates to the fourth set of coordinates to determine whether last digital pen stroke corresponds to the particular option.

16. A computer accessible medium comprising computer executable instructions for selecting a user-identified option from among a group of mutually exclusive options, the user-identified option being marked by a user with a digital pen on a paper form, the method comprising:
accessing a stroke collection file comprising data corresponding to a set of digital pen strokes;
determining a subset of digital pen strokes associated with the group of mutually exclusive options;
determining a last digital pen stroke in the subset made by the user, the last digital pen stroke being associated with a particular option in the group of mutually exclusive options; and
selecting the particular option associated with the last digital pen stroke as the user-identified option from among the group of mutually exclusive options.

17. The computer accessible medium of claim 16, wherein the method further comprises rendering an image of the paper form, the image comprising:
the group of mutually exclusive options; and
a single pen stroke among the group of mutually exclusive options, the single pen stroke comprising an image of the last digital pen stroke substantially located as marked by the user in relation to the particular option.

18. The computer accessible medium of claim 17, wherein rendering the image of the paper form comprises:
removing data from the stroke collection file corresponding to a first digital pen stroke in the subset made by the user; and
rendering the image based on the modified stroke collection file.

19. The computer accessible medium of claim 16, wherein selecting the particular option associated with the last digital pen stroke as the user-identified option comprises setting an option flag to the particular option, the option flag corresponding to the group of mutually exclusive options.

20. The computer accessible medium of claim 16, wherein determining the subset of digital pen strokes associated with the group of mutually exclusive options comprises:
associating the group of mutually exclusive options with an area on the paper form corresponding to a first set of coordinates;
accessing a second set of coordinates corresponding to a particular stroke in the stroke collection file; and
comparing the second set of coordinates to the first set of coordinates to determine whether the particular stroke was written within the area associated with the field.

21. The computer accessible medium of claim 20, wherein determining a last digital pen stroke in the subset comprises:
determining a stroke order for each of the digital pen strokes in the subset, the stroke order corresponding to an order in which the user wrote the stroke on the paper form using the digital pen; and
based on the stroke order, selecting the last digital pen stroke.

22. The computer accessible medium of claim 21, wherein the method further comprises:
selecting a third set of coordinates from among the first set of coordinates, the third set of coordinates corresponding to the particular option in the group of mutually exclusive options;
selecting a fourth set of coordinates from among the second set of coordinates, the fourth set of coordinates corresponding to the last digital pen stroke; and
comparing the third set of coordinates to the fourth set of coordinates to determine whether last digital pen stroke corresponds to the particular option.
